(19) United States
(12) Patent Application Publication
(10) Pub. No.: US 2014/0174695 A1
(43) Pub. Date: Jun. 26, 2014

(54) FIXING ASSEMBLY AND HEAT SINK USING FIXING ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: ZHEN-YU WANG, Kunshan (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/960,864

(22) Filed: Aug. 7, 2013

(30) Foreign Application Priority Data
Dec. 22, 2012 (CN) 2012105616504

(51) Int. Cl. F16B 41/00; F28F 3/00

(52) U.S. Cl. CPC F16B 41/002; F28F 3/00
USPC 165/76; 411/378

(57) ABSTRACT

A fixing assembly for use on an object which is to be attached to or detachable from another object includes a main body defining a through hole, a fixing member mounted to the through hole, and two limiting members secured to the main body and arranged at opposite sides of the through hole. When the fixing member is mounted to the through hole, the limiting members limit and hold captive the fixing member to prevent from falling off or displacement of the fixing member when not being used for attachment purposes. A heat sink using the fixing assembly is also provided.

### BACKGROUND

1. Technical Field

The present disclosure relates to fixing assemblies, and more particularly, to a fixing assembly for fixing heat sinks.

2. Description of Related Art

Referring to FIG. 6, a heat sink (not shown) is secured to a housing (not shown) by a typical assembly 400. The typical assembly 400 includes a fixing plate 410 fixed to the heat sink, a bolt 420 for securing the fixing plate 410 to the housing, and an elastic throttling member 430. The fixing plate 410 defines a though hole 412 having a diameter R1 and for mounting the bolt 420. The bolt 420 includes a head portion 422, a connecting portion 424 extending from the head portion 422, and a threaded shank 426 extending from an end of the connecting portion 424 away from the head portion 422. The diameter of the head portion 422 is greater than the diameter R1 of the through hole 420. The diameter of the connecting portion 424 is less than the diameter R1 of the through hole 420. The diameter of the threaded shank 426 is greater than the diameter of the connecting portion 424, but is less than the diameter R1 of the through hole 420 to allow the bolt 420 being easily mounted. The elastic throttling member 430 is substantially O-shaped or C shaped and defines a round hole 432. The outer diameter of the elastic throttling member 430 is greater than the diameter R1 of the through hole 420, and the inner diameter of the throttling member 430 is greater than the diameter of the connecting portion 424, but is less than the diameter of the threaded shank 426. However, to mount the bolt 420 to the fixing plate 410, the bolt 420 is first inserted into the through hole 422, then, the throttling member 430 is manually forced over the threaded shank 426 and sleeves on the connecting portion 424 to keep the bolt 420 in position on the fixing plate 410, which requires intricate and forceful assembling of the bolt 420.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of a heat sink including a fixing assembly in accordance with an embodiment.

FIG. 2 is a disassembled view of the fixing assembly in FIG. 1; the fixing assembly includes a fixing member.

FIG. 3 is an assembled view of the fixing assembly in FIG. 2.

FIG. 4 is a cross-sectional view taken along line IV-IV in FIG. 4.

FIG. 5 is a view showing the fixing member in FIG. 3 being mounted.

FIG. 6 illustrates a perspective view of a related art fixing assembly.

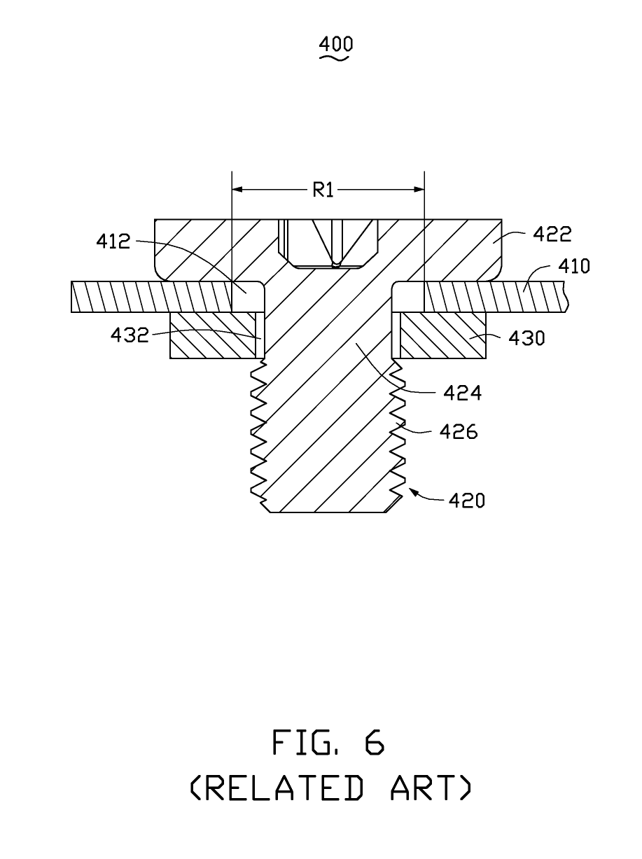

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

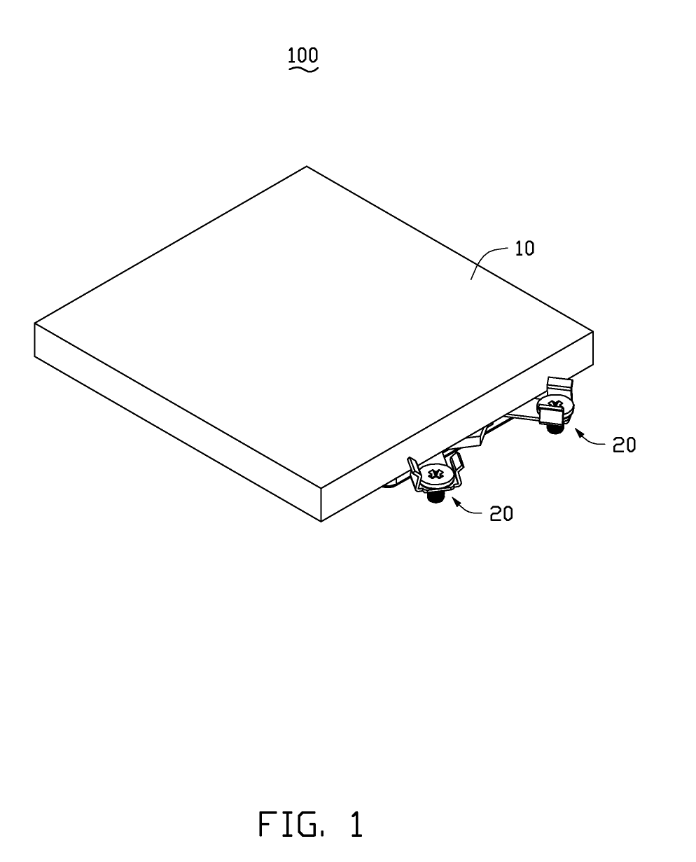

Referring to FIG. 1, a heat sink 100 in accordance with an embodiment is shown. The heat sink 100 includes a heat-dissipating module 10, and a plurality of fixing assemblies 20 for fixing the head-dissipating module 10 to a base (not shown).

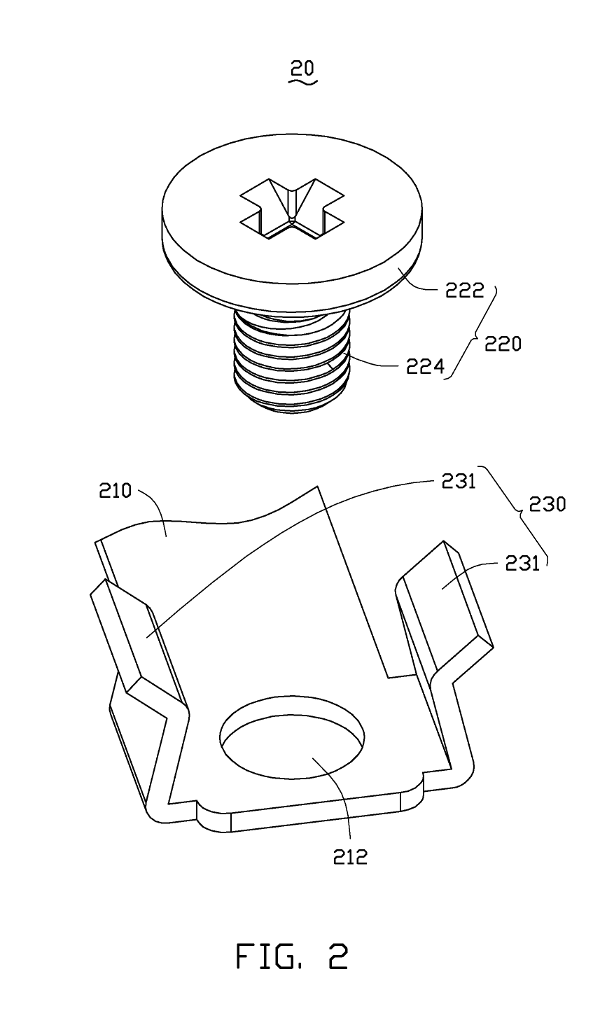

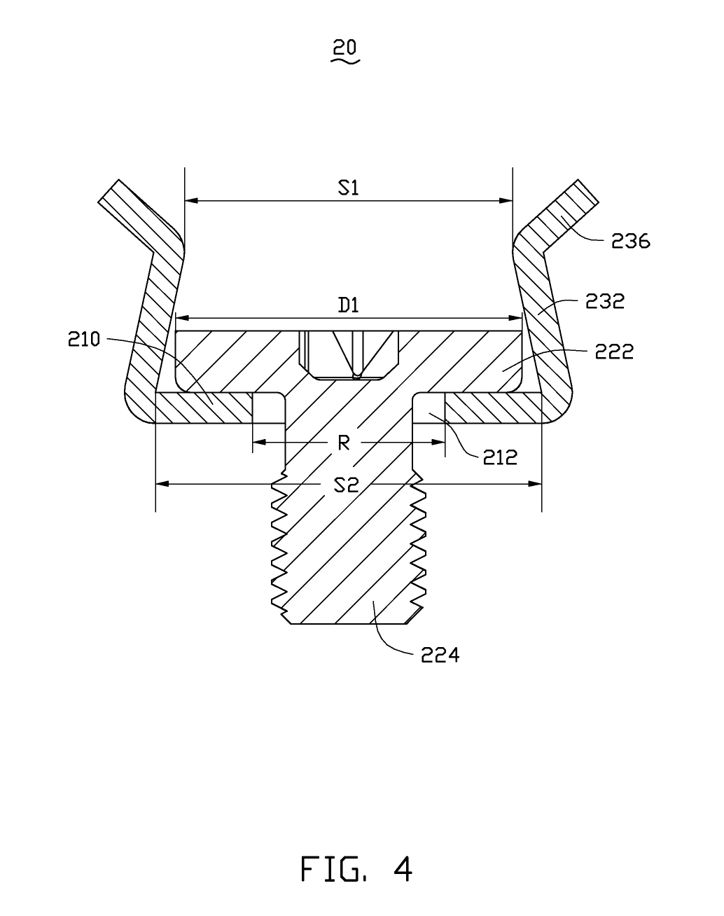

Referring to FIG. 2, each fixing assembly 20 includes a main body 210, a fixing member 220, and a limiting mechanism 230. The main body 210 is fixed to the heat-dissipating module 10. An end of the main body 220 away from the heat-dissipating module 10 defines a substantially round through hole 212 having a diameter R (see FIG. 4). The main body 210 in the embodiment is made of metal having high thermal conductivity, to provide high heat dissipation.

The fixing member 220 is mounted to the through hole 212, and is adapted to fix the main body 210 to the base. The fixing member 220 in the embodiment is a bolt. The fixing member 220 includes a head portion 222 and a threaded shank 224 fixed to the head portion 222. The diameter D1 (see FIG. 4) of the head portion 222 is greater than the diameter R of the through hole 212. The diameter of the threaded shank 224 is slightly less than the diameter R of the through hole 212 to allow entry of the fixing member 210.

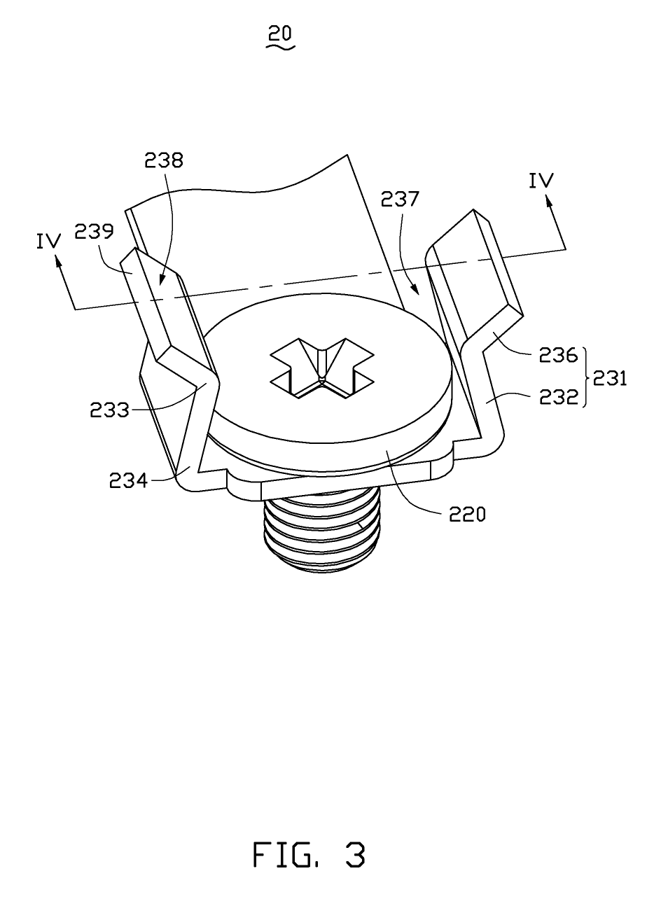

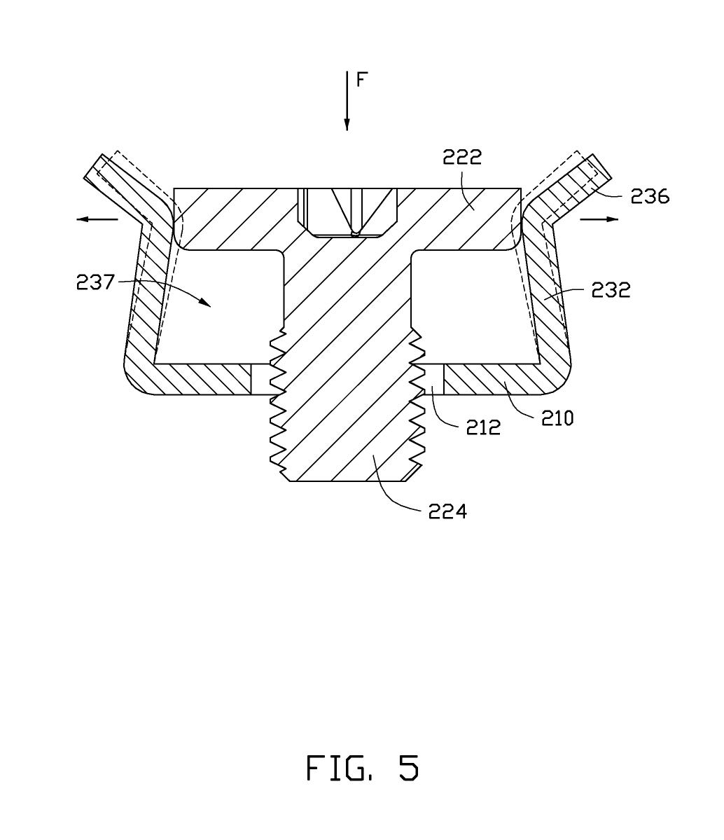

Referring also to FIG. 3, the limiting mechanism 230 is secured to the main body 210. The limiting mechanism 230 prevents the fixing member 220 from being displaced or falling off after the fixing member 220 is mounted to the main body 210. The limiting mechanism 230 includes two limiting members 231. The limiting members 231 are symmetrically arranged on either side of the through hole 212. The limiting members 231 in the embodiment integrally extend from opposite rims 214 of the main body 210. Each limiting member 231 is substantially V-shaped, and includes a stopping portion 232 and a guiding portion 236. The stopping portions 232 slantingly extend from the rims 214 towards each other. A limiting space 237 (see FIG. 5) is defined between the stopping portions 232 and communicates with the through hole 212. After the fixing member 220 is mounted to the main body 210, the head portion 222 is held captive in the limiting space 237. Each stopping portion 232 includes a first end 233 away from the main body 210 and a second end 234 opposite to the first end 233. The distance between each first end 233 and the main body 210 is greater than the thickness of the head portion 222. The distance S1 (see FIG. 4) between the first ends 233 of the stopping portions 232 is less than the diameter D1 of the head portion 222, and the distance S2 (see FIG. 4) between the second ends 234 of the stopping portions 232 is slightly greater than the diameter D1 of the head portion 222.

The guiding portions 236 bend from the first ends 233 and extend away from each other to form inclined surfaces 238. The distance between the distal ends 239 of the guiding portions 236 is greater than the diameter D1 of the head portion 222, for guiding the fixing member 220 to be inserted into the through hole 212.

Referring to FIG. 5, to mount the fixing member 220, the threaded shank 224 is aligned with the through hole 212 and the head portion 222 is placed between the guiding portions 236. Because the distance S1 between the first ends 233 is less than the diameter D1 of the head portion 222, the fixing member 220 is stopped by the first ends 233, and thumb pressure will push the head portion 222 along the inclined surface 239 in a direction perpendicular to the main body 210. During the movement of the fixing member 220, the head portion 222 pushes the guiding portions 236 outwards, and the stopping portions 232 elastically deform to enlarge the distance S1 between the first ends 233 to allow the head portion 222 to pass therethrough. Referring to FIGS. 3 and 4 again, after the head portion 222 passes through the first ends 233 and is further received in the limiting space 237, the stopping portions 232 restore to an original state with the distance S1 of the first ends 233 being less than the diameter of the head portion 222, and the head portion 222 is thus captive and limited by the first ends 233 to prevent loss or displacement.

In the embodiment, when the head portion 222 is received in the limiting space 237 and the stopping portions 232 restores to the original state, the head portion 222 abuts the main body 210, and an edge of an end of the head portion 222 away from the threaded shank 224 abuts the stopping portions 232. As a result, the limiting member 220 is tightly limited in movement.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A fixing assembly, comprising:
a main body defining a through hole;
a fixing member mounted to the through hole; and
two limiting members secured to the main body and arranged at opposite sides of the through hole;
wherein when the fixing member is mounted to the through hole, the limiting members limit and hold captive the fixing member to prevent the fixing member from falling off.

2. The fixing assembly of claim 1, wherein the fixing member comprises a head portion and a threaded shank fixed to the head portion, the diameter of the head portion is greater than the diameter of the through hole, and the diameter of the threaded shank is less than the diameter of the through hole.

3. The fixing assembly of claim 2, wherein each limiting member comprises a stopping portion, the stopping portion slantingly extends from the main body and toward the through hole.

4. The fixing assembly of claim 3, wherein the stopping portion comprises a first end away from the main body and a second end opposite to the first end; the distance between the first ends of the stopping portions is less than the diameter of the head portion, and the distance between the second ends of the stopping portions is greater than the diameter of the head portion.

5. The fixing assembly of claim 4, wherein each limiting member further comprises a guiding portion; the guiding portions extend from the first ends and away from each other.

6. The fixing assembly of claim 5, wherein the distance of the distal ends of the guiding portion away from the first ends is greater than the diameter of the head portion.

7. The fixing assembly of claim 1, wherein the limiting members are made of elastic material.

8. A heat sink, comprising:
a heat-dissipating module; and
a fixing assembly for fixing the heat-dissipating module, the fixing assembly comprising:
a main body fixed to the heat-dissipating module and defining a through hole;
a fixing member mounted to the through hole; and
two limiting members secured to the main body and arranged at opposite sides of the through hole;
wherein when the fixing member is mounted to the through hole, the limiting members limit and hold captive the fixing member to prevent the fixing member from falling off.

9. The heat sink of claim 8, wherein the fixing member comprises a head portion and a threaded shank fixed to the head portion, the diameter of the head portion is greater than the diameter of the through hole, and the diameter of the threaded shank is less than the diameter of the through hole.

10. The heat sink of claim 9, wherein each limiting member comprises a stopping portion, the stopping portion slantingly extends from the main body and toward the through hole.

11. The heat sink of claim 10, wherein the stopping portion comprises a first end away from the main body and a second end opposite to the first end; the distance between the first ends of the stopping portions is less than the diameter of the head portion, and the distance between the second ends of the stopping portions is greater than the diameter of the head portion.

12. The heat sink of claim 11, wherein each limiting member further comprises a guiding portion; the guiding portions extend from the first ends and away from each other.

13. The heat sink of claim 12, wherein the distance of the distal ends of the guiding portion away from the first ends is greater than the diameter of the head portion.

14. The heat sink of claim 8, wherein the limiting members are made of elastic material.
